(19) United States
(12) Patent Application Publication
(10) Pub. No.: US 2026/0233413 A1
(43) Pub. Date: Aug. 13, 2026

(54) APPARATUS FOR GRIPPING AND MOVING PRODUCTS FOR AUTOMATED MACHINES WITHIN PLANTS FOR PROCESSING AND TRANSPORTING PRODUCTS

(71) Applicants: Silvio CASONI, SCANDIANO (PR) (IT); Daniele ABELZI, Parma (IT)

(72) Inventors: Silvio CASONI, SCANDIANO (PR) (IT); Daniele ABELZI, Parma (IT)

(21) Appl. No.: 19/150,651

(22) PCT Filed: Dec. 29, 2023
(86) PCT No.: PCT/IB2023/063376

§ 371 Date: Jul. 24, 2025

(30) Foreign Application Priority Data
Jan. 25, 2023 (IT) 102023000001119

(51) Int. Cl. B25J 15/02; B65G 47/90

(52) U.S. Cl. CPC B25J 15/0246; B25J 15/0226; B65G 47/90

(57) ABSTRACT

An apparatus for moving products includes a gripper configured to grip and release a product. The gripper having a body, first and second jaws, for gripping and releasing the product, rotatably installed on the body to move relative to each other between a close position and a distant position. The apparatus also includes a transmission element movably mounted on the body, translating between an advanced position and a retracted position. During translation, it cooperates with the first and second jaws to bring them from the retracted position for disengaging and releasing the product to the close position for engaging and gripping the product or vice versa. The apparatus also includes first actuating means to translate the transmission element to the retracted position, second actuating means to translate said transmission element to an advanced position. The first actuating and/or second actuating means operate according to magnetic forces of attraction and/or repulsion.

### CROSS-REFERENCE TO RELATED APPLICATIONS

This application is a 8371 U.S. National Phase of PCT/IB2023/063376, filed Dec. 29, 2023, which claims priority of Italian Patent Application No. 102023000001119, filed Jan. 23, 2023, the entire contents of all of which are incorporated by reference herein as if fully set forth.

### FIELD OF THE INVENTION

The present invention is part of the field of apparatuses for gripping and moving products, for automated machines within plants for processing and transporting products.

More precisely, the present invention relates to an apparatus designed to retain and move products such as containers, preferably bottles, which are processed within automated machines or in the passage between one machine and another, for example for forming, filling, packing said containers, in particular bottles.

### BACKGROUND

Plants for the manufacture and processing of products are known in various configurations of the prior art.

The term products is intended as products of any kind that need to be handled for the manufacture, or packaging or transport thereof, etc.

In particular, in the following we will refer more frequently to the handling of containers, for example PET bottles, glass bottles, jars, cans etc.

For example, in the case of PET bottles, said plants may include machines that process said product from the parison up to the full bottle and eventually packaging.

Said systems may include various machines such as an oven, blowing machine, buffer, filling machine, capping machine, labelling machine, palletizer, etc.

Said machines are generally arranged in series and connected by conveyor belts that transfer containers from one processing station to the next.

In said plants, apparatuses for gripping and moving products are used, which involve moving products within several machines and/or on the transfer path between one machine and another.

In particular, said apparatuses comprise gripping devices suitable for retaining containers, preferably bottles, and generally configured to retain a single bottle preferably on the neck.

Prior art apparatuses are known comprising gripping devices movable between an opening position and a closing position by distancing or approaching gripping elements configured to engage on said product. The closing is carried out to retain the product and the opening to release it.

Said opening and closing movements are normally obtained by mechanical means such as gears, springs, cams, etc. which act on said gripping elements for the movement thereof. There are several variants that provide to open or close the gripping device acting by means of mechanical forces operating by contact or by means of magnetic attraction or repulsion forces.

For example, a well-known solution provides that the opening or closing of the gripping device occurs by acting on one of the two gripping elements, the movement of which is actuated, for example, by contact with a cam placed along the working path of the gripping device.

Generally speaking, said gripping devices are configured to translate along the product movement path, which can be a linear or rotary path depending on the type of machine in which the gripping device operates. For example, along said path there are one or more cams on which a portion of the first gripping element interferes by means of mechanical contact.

Other solutions may include electric or pneumatic actuators that push or pull said first gripping element from the opening to the closing configuration and vice versa.

The movement of the second gripping element can be carried out by having the first gripping element cooperate directly with the second.

Therefore, one of the two gripping elements can be said to be “active”, i.e. operatively coupled with drive means, while the second gripping element is “passive” and actuated by means for transferring the motion from the first gripping element directly to the second.

For example, each of the two gripping elements comprises a toothed portion configured to engage directly with the toothed portion of the other gripping element.

The disadvantage of this solution is that the force or torque that is transmitted from the drive means to the active gripping element must be able to activate both the gripping elements.

Therefore, this high force or torque, acting on only one gripping element, causes premature wear and reduces service life thereof.

By contrast, said apparatuses and relative gripping devices must be reliable over time in order to ensure the hold of the container.

Alternatively, other solutions provide that the movement of the second gripping element can occur independently of the first one, by means of similar additional drive means such as cams or actuators.

In this case, both the first gripping element and the second gripping element are considered as active.

However, this solution is complex and has the disadvantage of requiring twice the number of drive means, resulting in high installation and maintenance costs.

As a large number of such gripping devices is often present in the machines, they must be particularly simple and easy to clean in order to meet the high demands on hygiene and maintenance.

All of these known solutions, on the other hand, result in a high wear of the components involved, which reduces reliability thereof over time. It further results in more complex and more difficult solutions for maintenance.

### SUMMARY

The technical problem underlying the present invention is to provide an apparatus for gripping and moving products, for automated machines within plants for processing and transporting products, which is structurally and functionally designed to overcome one or more of the limitations set forth above with reference to the prior art mentioned.

Within the scope of the aforesaid problem, one main object of the invention is to develop an apparatus for gripping and moving products, for automated machines within plants for processing and transporting products, which makes it possible to achieve a solution which is more reliable and less subject to wear over time.

A further object of the invention is to provide the art with an apparatus for gripping and moving products, for automated machines within plants for processing and transporting products as part of a simple rational solution that reduces the maintenance of the device.

In particular, the present invention makes available an apparatus for moving products, in particular for automated machines within plants for processing and transporting products, comprising a gripper configured for gripping and releasing a respective product.

Said gripper preferably comprises a body, a first and a second gripper jaw for gripping and releasing the respective product.

Preferably said first and second jaws are rotatably installed on said body.

In particular, said first and second gripping jaws are configured to move relative to each other between a close position for engaging and gripping the product and a distant position for disengaging and releasing the product.

Preferably said apparatus further comprises a transmission element movably mounted on the body, configured to translate between an advanced and a retracted position in which, during said translation, it cooperates with the respective first and second jaws to bring them from the distant position for disengaging and releasing the product to the close position for engaging and gripping the product or vice versa.

Thanks to this solution, the closing force is equally distributed over both jaws by the transmission element.

Preferably said apparatus further comprises first actuating means to translate said transmission element into a retracted position and second actuating means to translate said transmission element into an advanced position.

In particular, said first actuating means and/or said second actuating means operate according to magnetic forces of attraction and/or repulsion.

Thanks to this solution the mechanical contacts between components are reduced, and thus wear and tear over time.

Optionally said first actuating means and/or said second actuating means comprise at least one pair of magnetic elements, a first magnetic element of which is integral with said transmission element and a second magnetic element is integral with the body.

Thanks to this characteristic, a simple and compact solution is obtained.

Preferably, said first and/or second jaws comprise a respective first and second pivot having rotation axes parallel to each other.

Said solution allows to reduce the overall dimensions of the gripper, especially when the jaws are in the open configuration.

In particular, said pivots are preferably placed at a first end of said first and/or second jaws.

Preferably said first and/or second jaw comprise a gripping section located at a second end away from said first and/or second pivot, preferably protruding from the body and shaped to engage/disengage with the product.

Advantageously, the transmission element comprises an elongated body that develops according to an axis in the translation direction and is interposed between the respective first and second jaws.

Optionally, the pair of magnetic elements is placed between the pivots and a second end of the body, of the transmission element facing the gripping section.

Optionally, said first actuating means and/or said second actuating means comprise an auxiliary pair of magnetic elements placed between the pivots and a first end of the body, of the transmission element, facing away from the gripping section.

Thanks to this solution, it is possible to increase the force of the gripper without using too large and bulky magnets.

Optionally, said first actuating means act according to magnetic repulsion forces.

Optionally, said second actuating means operate by mechanical contact.

In particular, said transmission element cooperates with both the first and second jaws with or without contact.

Preferably, the transmission element comprises a main transmission portion integral thereto which, during the translation of the transmission element, cooperates with a secondary transmission portion of the first and second jaws to have said first and/or second jaws rotate around the respective pivot in a way that is operatively related, preferably synchronised, with each other.

In particular, the main transmission portion extends along the body preferably in a central area.

Preferably, the secondary transmission portion is arranged according to a circumferential portion around the rotation axes.

In particular, the secondary transmission portion is rotatably integral with the respective first and second jaws configured such that the rotation of the second transmission portion imparts a rotation to the respective first jaw and second jaw.

Optionally, the main transmission portion cooperates with the secondary transmission portion without contact by means of magnetic attraction/repulsion forces.

Thanks to this solution mechanical contacts between components are reduced improving durability over time.

Optionally, the main transmission portion cooperates with the secondary transmission portion via mechanically coupled contact.

Preferably, the secondary transmission portion comprises a plurality of teeth, or lobes, that engage with a corresponding toothing, or lobing, of the main transmission portion.

Thanks to this solution greater precision in positioning the jaws is obtained.

Preferably the main transmission portion comprises a sequence of main magnetic elements and the secondary transmission portion comprises a sequence of secondary magnetic elements, in particular permanent magnets, respectively.

Preferably, said magnets are arranged so that each one has an opposite polarity in relation to the previous and the following ones.

Thanks to this solution, it is possible to make the jaws rotate as the transmission element translates.

In particular, the sequence of main magnetic elements comprises a plurality of magnetic elements arranged aligned along the main transmission portion.

Said plurality of magnetic elements may preferably be arranged on the corresponding toothing, or lobing.

In particular, the sequence of secondary magnetic elements comprises a succession of magnetic elements arranged according to a circumferential portion around the rotation axes.

Preferably, said magnets are arranged so that each one has an opposite polarity in relation to the previous and the following ones.

This succession of magnetic elements may preferably be arranged on the plurality of teeth, or lobes, of the secondary transmission portion.

An object of the invention is also a gripper for use in an apparatus for moving products, in particular for automated machines in plants for processing and transporting products, made according to any one of the preceding features.

Such and other objects are achieved by virtue of the features of the invention reported in independent claim 1. The dependent claims outline preferred and/or particularly advantageous aspects of the invention.

Said objects and advantages are all achieved by the apparatus for gripping and moving products, for automated machines in plants for processing and transporting products, object of the present invention, which is characterized by the following claims.

### BRIEF DESCRIPTION OF THE DRAWINGS

These and other features will be more apparent from the following description of certain embodiments illustrated by way of non-limiting example in the accompanying drawings.

FIG. 1: shows an axonometric view of an apparatus;

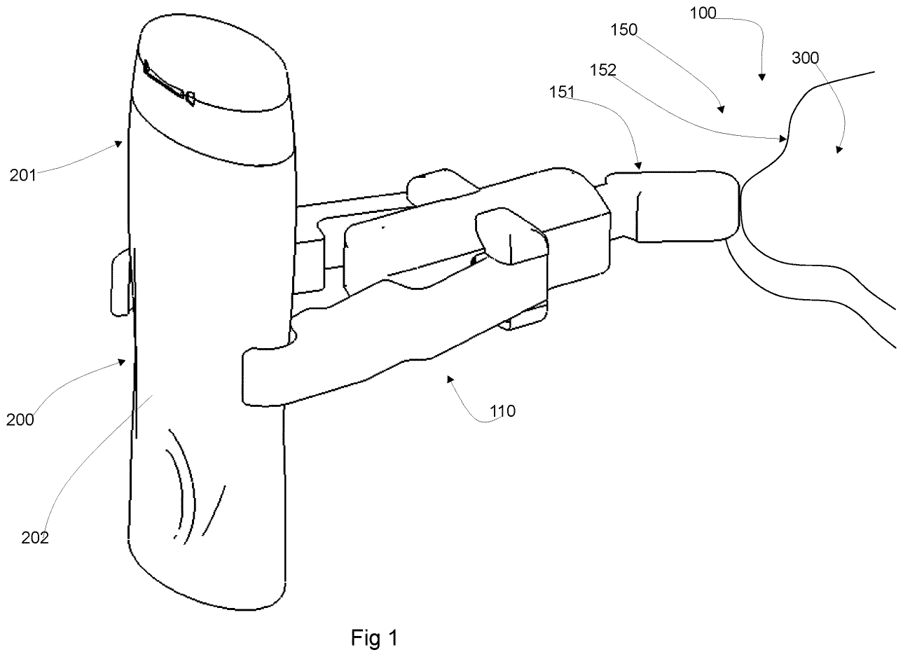

FIG. 2: shows an axonometric view of a gripper;

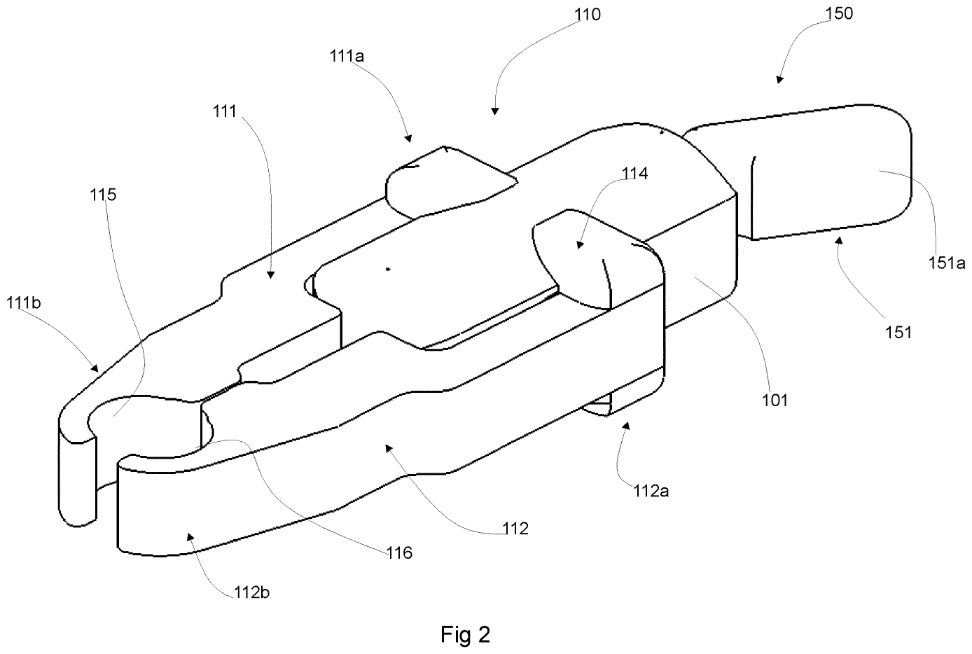

FIGS. 3a, 3b: shows a plan view of a gripper in open and close configuration;

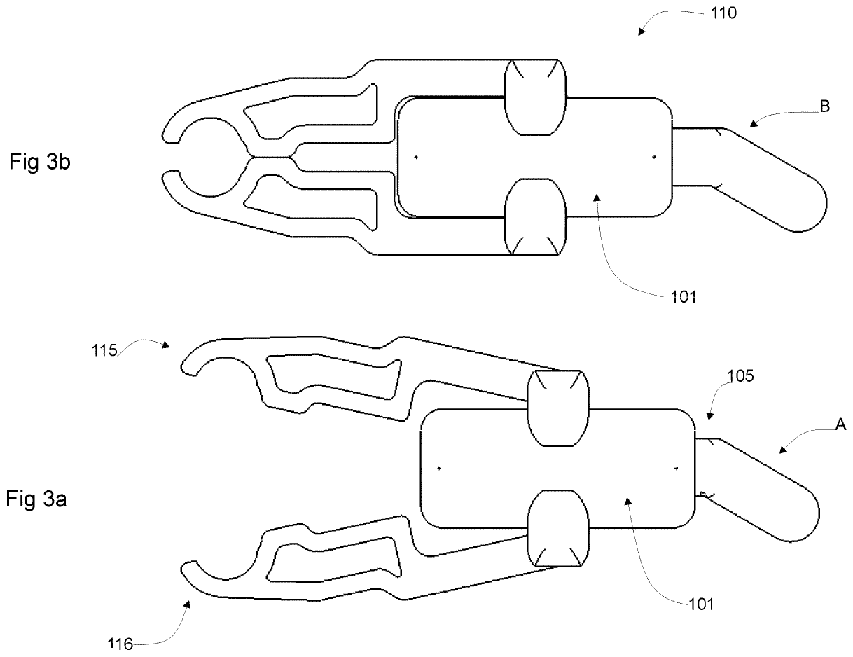

FIG. 4: shows a section view of a gripper in an open configuration;

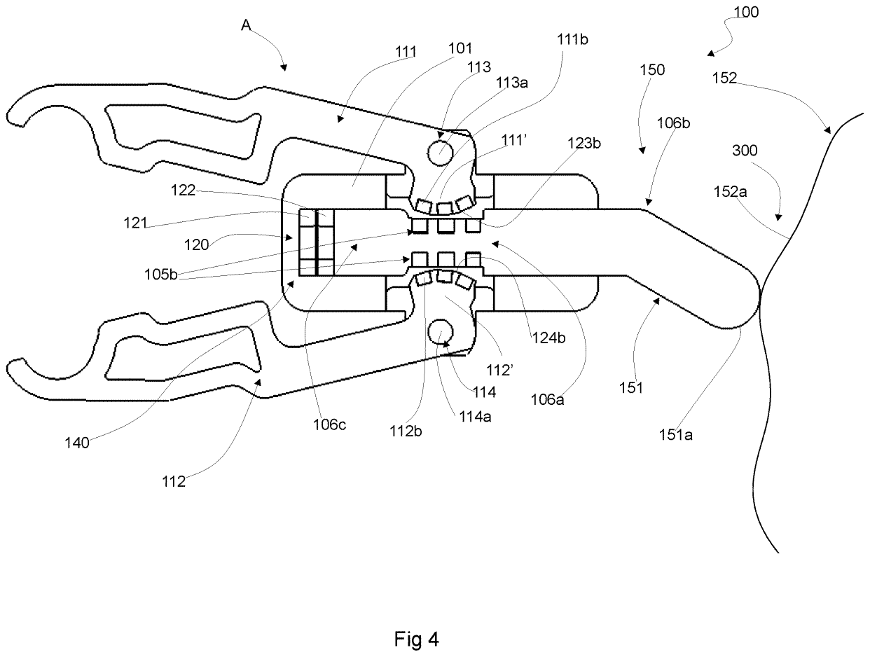

FIG. 5: shows a section view of a gripper in a close configuration.

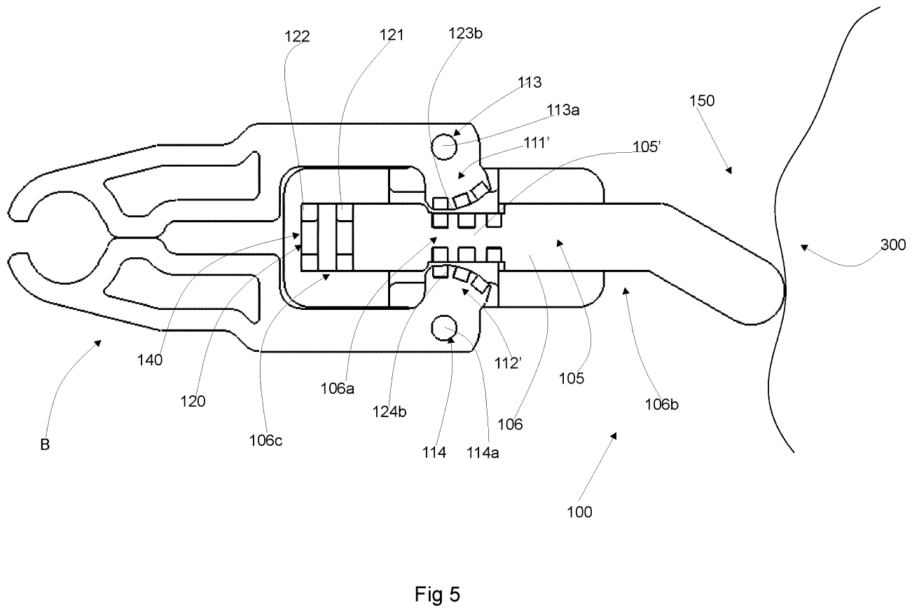

### DETAILED DESCRIPTION OF THE PREFERRED EMBODIMENTS

Referring in particular to the figure, an apparatus 100 for moving products 200, in particular for automated machines in plants for processing and transporting products, is shown.

Said products can be either loose or packaged products 200. Generally speaking, they are products 200 that need to be handled within automated or semi-automated systems in order to undergo the processing operations required for the manufacture thereof. The handling provides retaining and moving said products 200 both within the processing stations or machines and in the transfer between machines.

In particular among packaged products that can be handled, we will most frequently refer to containers in general and more specifically to containers such as PET bottles, glass bottles, jars, cans, etc.

The apparatus 100 object of the invention comprises a gripper 110 configured for gripping and releasing a respective product 200.

Therefore, the gripper 110 is preferably configured to act with a single product 200 at a time, although variants may provide that the gripper 110 is configured to grip and release more than one product 200 at a time.

A preferred embodiment further includes that the apparatus 100 comprises more than one gripper 110, preferably a plurality of grippers 110. The number of grippers 110 can be linked to the type of machine in which the apparatus is inserted, the production rate of said machine, the type of container, etc.

According to an aspect of the invention, said one or more grippers 110 may be configured to carry out the grip and release of a respective product 200 while remaining in a fixed position within the apparatus 100.

Alternatively said one or more grippers 110 may be configured to carry out the grip and release of a respective product 200 by being movable along a movement path of the products 200.

Said aspect also depends on the type of machine to which the apparatus 100 is operatively connected.

According to a preferred embodiment, said gripper 110 comprises a first jaw 111 and a second jaw 112 for gripping and releasing the respective product 200.

Said first and/or second jaw 111, 112 are relatively movable between a close engagement and gripping position of the product 200 and a distant disengagement and releasing position of the product 200.

The figures show a preferred embodiment in which both the first and second jaw 111, 112 are movable between a close engagement and gripping position of the product 200 and a distant disengagement and releasing position of the product 200.

Preferably, the embodiment shown in the figures provides that said first and second jaws 111, 112 move away from or close to each other symmetrically with respect to the product 200 to be retained.

However, it is understood that the foregoing is intended to be illustrative and not limiting, so that any variants including a non-symmetrical movement of the first and second jaw 111, 112 are deemed to fall within the scope of protection of the invention.

Furthermore, said first and/or second jaws 111, 112 can be configured so that the movement of one relative to the other occurs by rotation.

In particular, said gripper 110 comprises a body 101, on which said first and second jaws 111, 112 are rotatably installed to move relative to each other, in particular between a close position for engaging and gripping the product 200 and a distant position for disengaging and releasing the product 200.

Said body 101 can be configured to be movably installed on the apparatus 100.

A preferred configuration is shown in the figure, in which the first and/or second jaw 111, 112 are rotatable about a respective first and second pivot 113, 114 having axes of rotation 113a, 114a parallel to each other.

Said pivots 113, 114 are preferably placed at a first end 111a, 112a of said first and/or second jaw 111, 112.

In particular, the first and/or second jaw 111, 112 comprise a gripping section 115, 116 placed at a second end 111b, 112b.

In the above-described configuration, said second end 111b, 112b is placed away from said pivots 113, 114.

In particular, the gripping section 115, 116 is shaped to engage/disengage with the product 200.

Preferably the second end 111b, 112b and therefore the gripping section 115, 116 protrudes from the body 101. Thanks to this configuration it is possible to have greater flexibility in the gripping type and position of the product 200.

Indeed, for example if the product 200 is a container, in particular a bottle, the gripping section 115, 116 of the respective jaws 111, 112 can be configured to engage on the body 202, or on the neck 201 of said container 200. In the figure, the first and second jaws, shaped to be able to grip the container 200 at the neck 201, are shown. This grip is particularly used in the PET bottle movement sector.

The shape of the gripping section 115, 116, the position and length of the respective jaws 111, 112, vary as a function of the type of product 200 and the gripping position of said product 200.

In accordance with the aforesaid objects, the invention relates to an apparatus in which the gripping and releasing of the product 200, occurs by means of said first and/or second jaw 111, 112 relatively movable between a close engagement and gripping position of the product 200 and a distant disengagement and releasing position of the product 200.

To carry out the grip and release of the product 200, the apparatus 100 comprises a transmission element 105 movably mounted on the body 101.

Said transmission element 105 is preferably configured to translate between an advanced position A and a retracted position B.

Advanced position A means that the transmission element 105 moves closer to the gripping section 115, 116 of the respective jaws 111, 112.

Retracted position B means that the transmission element 105 is away from the gripping section 115, 116 of the respective jaws 111, 112.

In particular, during said translation, the transmission element 105 cooperates with the respective first and second jaws 111, 112 to bring them from the close engagement and gripping position of the product 200 to the distant disengagement and releasing position of the product 200.

Thanks to this solution, the force or torque for moving the first and second jaws 111, 112 is distributed over both of them and there is no one jaw that is more stressed than the other and therefore more prone to wear.

Thus, the first and second jaws 111, 112 can both be considered as active elements and there is no passive element.

According to one aspect of the invention, the apparatus 100 further comprises:
first actuating means 140 to translate said transmission element 105 to the retracted position B
second actuating means 150 to translate said transmission element 105 to the advanced position A.

Preferably, the first actuating means 140 translate said transmission element 105 to a retracted position B in order to bring the first and second jaws 111, 112 into a close engagement and gripping position 200.

Preferably, the second actuating means 150 translate said transmission element 105 to the advanced position A to bring the first and second jaws 111, 112 to the distant position for disengaging and releasing the product 200.

According to one aspect of the invention, said transmission element 105 comprises an elongated body 106 extending along an axis X in the direction of translation.

In said elongated body 106 we define a first end 106b, a second end 106c and a central area 106a.

In particular, said first end 106b of the body 106 faces away from the gripping section 115, 116 of the gripper 110, while the second end 106c faces the gripping section 115, 116.

Advantageously, said transmission element 105 is interposed between the respective first and second jaws 111, 112.

In particular, said transmission element 105 cooperates with both the first and second jaws 111, 112.

Preferably, the translation of said transmission element 105 results in the rotation of the first jaw 111 and preferably results in an equal but opposite rotation of the second jaw 112.

This ensures that the gripper 110 opens/closes symmetrically with respect to the container 200.

Optionally, said transmission element 105 may cooperate with the first and second jaws 111, 112 by contact or without contact with said jaws 111, 112, as will be better described hereinafter.

Advantageously, said first actuating means 140 and/or said second actuating means 150 act on said transmission element 105 according to forces of attraction and/or repulsion of the magnetic type.

According to possible embodiments said first actuating means 140 and/or said second actuating means 150 comprise at least one pair of magnetic elements 120.

Preferably said pair of magnetic elements 120 comprises a first magnetic element 121 which is integral with said transmission element 105 and a second magnetic element 122, which is integral with the body 101.

In particular, said second magnetic element 122 can be mechanically locked to the body 101 by means of special seats with abutments or locking elements known to a person skilled in the art.

One embodiment provides that said first actuating means 140 and/or said second actuating means 150 comprise a pair of magnetic elements 120 placed in between the pivots 113, 114 and the second end 106c of the body 106, of the transmission element 105, preferably near said second end 106c.

Preferably said pair of magnetic elements 120 faces the same side as the gripping section 115, 116.

Advantageously, according to an embodiment not shown in the figure, said first actuating means 140 and/or said second actuating means 150 may comprise an auxiliary pair of magnetic elements comprising a first auxiliary magnetic element that is integral with the transmission element 105 and a second auxiliary magnetic element that is integral with the body 101.

Preferably said auxiliary pair of magnetic elements is placed between the pivots 113, 114 and the second end 106b of the body 106, preferably on the opposite side of the gripping section 115, 116 preferably in correspondence thereto.

Thus, the pair of magnetic elements 120, and the auxiliary pair of magnetic elements can be arranged in opposite positions to the pivots 113, 114.

Thanks to this solution, it is possible to ensure a higher closing force for the gripper 100, without using a large and bulky pair of magnetic elements 120.

A preferred embodiment shown in the figure provides that said first actuating means 140 act according to forces of magnetic repulsion.

The alternative solution wherein the first actuating means 140 operate through forces of magnetic repulsion is also the object of the invention.

According to a preferred embodiment, the first actuating means 140 are provided on the gripper 110.

Thus said first actuating means 140 are all installed on the gripper 110.

In the figure, the first actuating means 140 comprise a pair of magnetic elements 120.

A preferred embodiment provides that the pair of magnetic elements 120 comprises a first magnetic element 121 and a second magnetic element 122 that are permanent magnets.

Alternatively, the pair of magnetic elements 120 may comprise a first magnetic element 121 and a second magnetic element 122 that are of the electromagnet type.

A further alternative can provide that the first magnetic element 121 or the second magnetic element 122 are made of ferromagnetic material and therefore subject to the forces of magnetic attraction.

The same considerations regarding the possible types of the magnetic elements also apply to the auxiliary pair of magnetic elements, if present.

In a preferred embodiment wherein the first actuating means 140 act according to magnetic repulsion forces, the first magnetic element 121, which is integral with the transmission element 105 is arranged so that the positive pole faces the positive pole of the second magnetic element 122, which is integral with the body 101.

Or vice versa, the first magnetic element 121, which is integral with the transmission element 105 is arranged so that the negative pole faces the negative pole of the second magnetic element 122, which is integral with the body 101.

The same considerations also apply to the auxiliary pair of magnetic elements, if present.

One possible embodiment provides that when the transmission element 105 is in an advanced position A or in a retracted position B, the first magnetic element 121, which is integrally movable with said transmission element 105, does not protrude from the body 101.

This makes the gripper more compact.

A preferred embodiment shown in the figure provides that said second actuating means 150 operate by mechanical contact.

According to an aspect of the invention, as shown in the figure, the second actuating means 150 comprise a first mechanical engagement element 151 mechanically and operatively integral with the transmission element 105 and a second mechanical engagement element 152 installed in a gripping/releasing area 300 of the apparatus 100.

In particular, the embodiment shown in the figure provides that said first mechanical engagement element 151 and said second mechanical engagement element 152 preferably cooperate to open the gripper 110.

In particular, the first mechanical engagement element 151 and the second mechanical engagement element 152 cooperate, by mechanical contact, to carry out the translation of the transmission element 105 from the retracted position B to the advanced position A.

In the gripping/releasing area 300 of the apparatus 100, the gripper 110 switches from gripping to releasing the product 200 or vice versa.

In fact, normally the gripper 110 is kept in a close or gripping configuration by the first actuating means 140 and changes the configuration thereof at the gripping/releasing area 300.

Said gripping/releasing area 300 comprises the second mechanical engagement element 152 which is, for example, a profile 152a which the first mechanical engagement element 151, such as a skid 151a or roller, engages.

Preferably the first mechanical engagement element 151 is positioned on the transmission element 105 at the first end 106b of the elongated body 106, in particular on the opposite side of the gripping section 115, 116.

Further preferably the first mechanical engagement element 151 extends outwardly from the body 101, preferably both when the transmission element 105 is in the advanced A and retracted position B.

The apparatus 100 provides that there is a relative movement between the gripper 110 and the second mechanical engagement element 152.

Thus, when the gripper 110 and the second mechanical engagement element 152 are in a face-to-face position, the first mechanical engagement element 151 comes into contact with said second mechanical engagement element 152 and the gripper 110 changes its configuration from grip to release.

Preferably, the gripper 110 is movable along a product movement path 200 of the apparatus 100 and the second mechanical engagement element 152 is in a fixed position on said path.

According to an aspect of the invention, the transmission element 105 further comprises a main transmission portion 105′ integral thereto.

In particular, during the translation of the transmission element 105, said main transmission portion 105′, cooperates with a secondary transmission portion 111′, 112′ of the first and second jaws 111, 112 to make said first and second jaws 111, 112 rotate around their respective pivot 113, 114, in a way that is operatively related, preferably synchronised with each other.

Preferably the main transmission portion 105′ extends along the elongated body 106, preferably in the central area 106a of said elongated body 106.

Said main transmission portion 105′ may develop around the entire external lateral surface of the central area 106a or alternatively on two faces opposite with respect to the axis X and facing the first and second jaws 111, 112 respectively.

Thus, a possible embodiment of the transmission element 105, not shown in the figure, can provide the first magnetic element 121, the main transmission portion 105′ and, if present, the first auxiliary magnetic element.

Preferably the arrangement is sequential wherein the first magnetic element 121 is placed towards the second end 106c of the body 106, away from the gripping section 115, 116 of the gripper 110.

Further preferably, the first auxiliary magnetic element, if present, may be preceded by the first mechanical engagement element 151, on the side of the first end 106b.

The extended body 106 can be made in one single piece or in several pieces, for example with the first mechanical engagement element 151 detachable from the body 106 so as to facilitate the replacement of components most subject to wear.

Advantageously, the secondary transmission portion 111′, 112′ is arranged according to a circumferential portion 123b, 124b around the rotation axes 113a, 114a.

This allows the translation motion of the transmission element 105 to be transformed into rotary motion of the first and second jaws 111, 112.

In particular, said secondary transmission portion 111′, 112′ is rotatable integrally with the respective first and second jaws 111, 112 and configured in such a way that the rotation of the second transmission portion 111′, 112′ imparts a rotation to the respective first jaw 111 and second jaw 112. Preferably in a first embodiment, shown in the figure, the main transmission portion 105′, cooperates with the secondary transmission portion 111′, 112′ without contact by means of magnetic attraction/repulsion forces.

Thanks to this solution, mechanical contacts and thus the wear on the mechanical components involved are reduced and maintenance operations are simplified.

Alternatively, in a second embodiment, the main transmission portion 105′ cooperates with the secondary transmission portion 111′, 112′ by means of mechanically coupled contact.

This provides greater precision in the position of the first jaw 111 and second jaw 112.

According to the first embodiment, the main transmission portion 105′ can comprise a sequence of main magnetic elements 105b and the secondary transmission portion 111′, 112′ comprises a sequence of secondary magnetic elements 111′, 112′ respectively.

In particular, said magnetic elements can be permanent magnets preferably arranged so that each one has an opposite polarity in relation to the previous and the following ones of the respective sequence.

Preferably said sequence of secondary magnetic elements 111′, 112′ is arranged according to the circumferential portion 123b, 124b around the rotation axes 113a, 114a. Preferably, the sequence of main magnetic elements 105b comprises a plurality of magnetic elements aligned along the main transmission portion 105′.

Preferably the sequence of main magnetic elements 105b and/or the sequence of secondary magnetic elements 111′, 112′ can be electromagnet-type magnetic elements.

Advantageously, according to the second embodiment, the secondary transmission portion 111′, 112′ may comprise a plurality of teeth, or lobes, which engage with a corresponding toothing or lobing of the main transmission portion 105′.

A possible third embodiment provides that the sequence of main magnetic elements 105b can be placed on the corresponding toothing, or lobing.

In said third embodiment, preferably also the sequence of secondary magnetic elements 111′, 112′ can be placed on the plurality of teeth, or lobes, of the secondary transmission portion 111′, 112′.

Advantageously, there is an airgap/port between the toothing or lobing and the plurality of teeth or lobes, i.e. they cooperate without contact.

Thanks to this solution, motion is transferred from the first jaw 111 to the second jaw 112 without contact between the components involved, unlike with gears alone, or with connecting rods, clutches, etc.

This ensures a greater reliability and durability of the gripper 110 over time.

It also simplifies the hygienic design of the gripper, simplifying maintenance operations.

In said third embodiment, the presence of the toothing, or lobing, and the plurality of teeth, or lobes, helps to define the correct position and symmetry of the first and second jaws 111, 112, relative to each other.

According to a preferred embodiment, the gripper 110 and in particular the first and/or second jaw 111, 112 and/or the body 101 and/or the transmission element 105, are made of plastic material.

Thanks to this solution it is possible to create a lightweight 110 gripper.

Further, this solution does not require bushings, sealing rings or translating seals for translation and/or rotation, reducing the number of components and the complexity of the gripper 110.

An advantageous embodiment can provide that the first and/or second jaws 111, 112 comprise cavities or orifices that are intended to lighten the gripper 110, leaving the material only in the most stressed sections.

A further object of the invention is the gripper 110 usable in the apparatus 100 for moving products 200, in particular for automated machines in plants for processing and transporting products 200, configured according to the features described above.

It is in any case understood that the foregoing is given by way of exemplary and non-limiting purposes, therefore possible detail variants that may be required for technical and/or functional reasons are considered from now as falling within the same protective scope defined by the below-reported claims.

1. An apparatus for moving products, the apparatus comprising:
a gripper configured to grip and release a respective product, said gripper comprising:
a body,
a first and a second jaw for gripping and releasing the respective product, said first and second jaws being rotatably installed on said body to move relative to each other between a close position for engaging and gripping the product and a distant position for disengaging and releasing the product,
a transmission element movably mounted on the body, translating between an advanced position and a retracted position wherein during said translation the transmission element cooperates with the respective first and second jaws to bring them from the distant position for disengaging and releasing the product to the close position for engaging and gripping the product or vice versa,
first actuating means to translate said transmission element to the retracted position, and
second actuating means to translate said transmission element to the advanced position,
wherein said first actuating means and/or said second actuating means operate according to magnetic forces of attraction and/or repulsion.

2. The apparatus according to claim 1, wherein said first actuating means and/or said second actuating means comprise at least one pair of magnetic elements a first magnetic element of which is integral with said transmission element and a second magnetic element is integral with the body.

3. The apparatus, according to claim 1, wherein said first and second jaws comprise respective first and second pivots having rotation axes parallel to each other, said pivots being placed at a first end of said first and second jaws.

4. The apparatus according to claim 3, wherein the first and/or the second jaw comprise a gripping section placed at a second end away from said first and/or second pivot, protruding from the body and shaped to engage with/disengage from the product.

5. The apparatus according to claim 1, wherein the transmission element comprises an elongated body which extends along an axis in the translation direction and is interposed between the respective first and second jaws.

6. The apparatus, according to claim 2, wherein the pair of magnetic elements is placed between the pivots and a second end of the body, of the transmission element, facing the gripping section 115, 116.

7. The apparatus according to claim 2, wherein said first actuating means and/or said second actuating means comprise an auxiliary pair of magnetic elements placed between the pivots and a first end of the body, of the transmission element, facing away from the gripping section.

8. The apparatus, according to claim 1 wherein said first actuating means act according to magnetic repulsion force.

9. The apparatus, according to claim 1, wherein said second actuating means operate by mechanical contact.

10. The apparatus according to claim 1, wherein said transmission element cooperates with both the first and second jaws with or without contact.

11. The apparatus, according to claim 3, wherein the transmission element comprises a main transmission portion integral thereto which, during the translation of the transmission element, cooperates with a secondary transmission portion of the first and second jaws to have said first and/or second jaws rotate about the respective pivot, in a way that is operatively related, preferably synchronised, with each other.

12. The apparatus, according to claim 11, wherein the main transmission portion extends along the body in a central area.

13. The apparatus, according to claim 11, wherein the secondary transmission portion is arranged according to a circumferential portion around the rotation axes.

14. The apparatus, according to claim 11, wherein the secondary transmission portion is rotatably integral with the respective first and second jaws configured such that the rotation of the second transmission portion imparts a rotation to the respective first jaw and second jaw.

15. The apparatus, according to claim 11, wherein the main transmission portion cooperates with the secondary transmission portion without contact by means of magnetic attraction/repulsion forces.

16. The apparatus, according to claim 11, wherein the main transmission portion cooperates with the secondary transmission portion via mechanically coupled contact.

17. The apparatus, according to claim 11, wherein the secondary transmission portion comprises a plurality of teeth, or lobes, which engage with a corresponding toothing, or lobing, of the main transmission portion.

18. The apparatus according to claim 11, wherein the main transmission portion comprises a sequence of main magnetic elements and the secondary transmission portion respectively comprises a sequence of secondary magnetic elements arranged so that each one has an opposite polarity in relation to the previous and the following ones.

19. The apparatus, according to claim 18, wherein the sequence of main magnetic elements comprises a plurality of magnetic elements arranged aligned along the main transmission portion on the corresponding toothing, or lobing.

20. The apparatus, according to claim 18, wherein the sequence of secondary magnetic elements comprises a succession of magnetic elements arranged according to a circumferential portion about the rotation axes, on the plurality of teeth, or lobes, of the secondary transmission portion arranged so that each one has an opposite polarity in relation to the previous and the following ones.

21. (canceled)
